(19) United States
(12) Patent Application Publication
(10) Pub. No.: US 2024/0062538 A1
(43) Pub. Date: Feb. 22, 2024

(54) IDENTIFYING THERMOCLINES IN AN AQUACULTURE ENVIRONMENT

(71) Applicant: X Development LLC, Mountain View, CA (US)

(72) Inventors: Bianca Bahman, SAN FRANCISCO, CA (US); Bertrand Louis Rene Delorme, San Francisco, CA (US); Antoni Jordi Ballester, San Francisco, CA (US)

(21) Appl. No.: 18/234,528

(22) Filed: Aug. 16, 2023

Related U.S. Application Data
(60) Provisional application No. 63/399,354, filed on Aug. 19, 2022.

(51) Int. Cl. G06V 20/05; G06V 40/10; A01K 61/95; A01K 61/80

(52) U.S. Cl. CPC G06V 20/05; G06V 40/10; A01K 61/95; A01K 61/80

(57) ABSTRACT

Methods, systems, and apparatus, including medium-encoded computer program products, for obtaining a plurality of images from at least one imaging device in an aquaculture environment and determining a statistical distribution of the livestock in the aquaculture environment from the plurality of images. Based on the statistical distribution, a location of a thermocline in the aquaculture environment can be determined. A signal indicative of the location of the thermocline can be provided to an aquaculture management device in the aquaculture environment.

### CROSS-REFERENCE TO RELATED APPLICATIONS

This application claims benefit of U.S. Provisional Application No. 63/399,354, filed on Aug. 19, 2022, the entireties of which are herein incorporated by reference.

### FIELD

This specification relates to underwater camera systems and, in one example implementation, describes image-based techniques for identifying thermoclines in an aquaculture environment.

### BACKGROUND

A thermocline is a distinct layer in a fluid in which temperature changes more rapidly with depth than it does in the fluid above or below the thermocline. A diurnal thermocline is a type of thermocline that is formed at certain depths during certain times of day hours.

### SUMMARY

This specification describes techniques for using legacy equipment that exists within an aquaculture environment and that is used for other purposes, e.g., underwater camera systems that are used for fish biomass estimation, to also detect the presence and depth of thermoclines. These techniques can be used, for example, to identify thermoclines, including diurnal thermoclines. In this regard, data that is already provided by this legacy equipment can be repurposed for new uses, without requiring new sensors to be introduced into the environment.

Particular embodiments of the subject matter described in this specification can be implemented so as to realize one or more of the following advantages. The techniques described below can be used to detect thermoclines without the addition of temperature sensors, which are often not present in aquaculture environments, since the introduction of temperature sensors can increase the cost of maintaining the aquaculture infrastructure. In addition, since the presence of warm-blooded livestock around a temperature sensor has the potential to create spurious temperature readings, detecting thermoclines using techniques that do not rely on temperature sensors can be beneficial. Further, the techniques can be used to detect thermoclines without being sensitive to temporary livestock behavior, such as movements associated with feeding.

In an aspect, the subject matter described in this specification can be embodied in methods that include obtaining a plurality of images from at least one imaging device in an aquaculture environment, each image in the plurality of images representing livestock in the aquaculture environment; determining, from at least the plurality of images, a statistical distribution of the livestock in the aquaculture environment; determining, from the statistical distribution of the livestock, a location of a thermocline in the aquaculture environment; and providing, to an aquaculture management device in the aquaculture environment, a signal indicative of the location of the thermocline.

The foregoing and other embodiments can each optionally include one or more of the following features, alone or in combination.

In some implementations, the method includes determining, based on the location of the thermocline, that the thermocline is a diurnal thermocline; and based on determining that the thermocline is a diurnal thermocline, modifying operation of the aquaculture management device.

In some implementations, the aquaculture management device is a feeder and modifying operation of the feeder includes adjusting, according to the signal indicative of the location of the thermocline, at least one of (i) an amount of feed to disperse, or (ii) a location in the aquaculture environment to disperse the feed.

In some implementations, the aquaculture management device is a parasite remediation system, wherein operations of the parasite remediation system are adjusted in based on the signal indicative of the location of the thermocline.

In some implementations, the aquaculture management device is a camera device and modifying operation of the camera device includes adjusting, according to the signal indicative of the location of the thermocline, at least one of (i) a position, or (ii) a capture rate, of the camera device.

In some implementations, the method includes obtaining, from at least one sensor in the aquaculture environment, one or more sensor readings capturing at least one measurement of the aquaculture environment. The location of a diurnal thermocline is determined, at least in part, using the one or more sensor readings. In some implementations, the method includes determining, from at least one sensor reading among the one or more sensor readings, at least one environment descriptor for the aquaculture environment, and estimating the location of a thermocline according to the at least one environmental descriptor. The at least one environmental descriptor can indicate a predicted measure of the aquaculture environment.

In some implementations, the location of a diurnal thermocline is determined by a machine learning model. In some implementations, the location of a diurnal thermocline is determined by a model configured to perform one or more statistical techniques.

In some implementations the statistical distribution includes one or more measurements of estimated number of livestock in the aquaculture pen, each measurement representing a number of livestock in the aquaculture environment at a corresponding depth of the aquaculture environment. In some implementations the statistical distribution includes one or more measurements of estimated biomass in the aquaculture pen, each measurement representing biomass of the aquaculture environment at a corresponding depth of the aquaculture environment.

In an aspect, a system can include one or more processors, and machine-readable media interoperably coupled with the one or more processors and storing one or more instructions that, when executed by the one or more processors, perform operations that include obtaining a plurality of images from at least one imaging device in an aquaculture environment, each image in the plurality of images representing livestock in the aquaculture environment; determining, from at least the plurality of images, a statistical distribution of the livestock in the aquaculture environment; determining, from the statistical distribution of the livestock, a location of a thermocline in the aquaculture environment; and providing, to an aquaculture management device in the aquaculture environment, a signal indicative of the location of the thermocline.

In an aspect, a non-transitory computer-readable medium storing one or more instructions executable by a computer system to perform operations of obtaining a plurality of images from at least one imaging device in an aquaculture environment, each image in the plurality of images representing livestock in the aquaculture environment; determining, from at least the plurality of images, a statistical distribution of the livestock in the aquaculture environment; determining, from the statistical distribution of the livestock, a location of a thermocline in the aquaculture environment; and providing, to an aquaculture management device in the aquaculture environment, a signal indicative of the location of the thermocline.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1A shows an example of determining thermoclines in an aquaculture environment.

FIG. 1B shows an example of locating a thermocline in an aquaculture environment.

FIG. 1C shows an example graph of a thermocline location in an aquaculture environment.

FIG. 2 shows an example of an environment for determining thermoclines in an aquaculture environment.

FIG. 3 is a flow diagram of an example process for determining thermoclines in an aquaculture environment.

### DETAILED DESCRIPTION

Aquaculture is the farming of marine organisms e.g., fish, algae, seaweed, crustaceans, and mollusks in controlled aquatic environments. Aquaculture is important to the health of marine ecosystems, which can suffer from overharvesting. Experience indicates over half of all fish and shellfish consumed by humans come from aquaculture, and in the absence of aquaculture, substantial, and perhaps irreversible, strain on marine ecosystems could result.

Aquaculture plays an important role in mitigating climate change, as aquaculture farming practices have a smaller carbon footprint, and demand less land and fresh water relative to other types of livestock farming. Therefore, aquaculture is more sustainable and efficient at converting feed into protein for human consumption than beef, pork, and poultry. Further, aquaculture tends to be more resilient to the impacts of climate change, as many aquaculture operations are safe from tornados, droughts, floods, and other land-based extreme events that may increase in frequency and intensity due to the effects of climate change.

A thermocline is boundary layer in a body of water that indicates different temperatures between an upper region of water above the boundary layer and a lower region of water below the boundary layer. Thermoclines can also be referred to as temperature gradients in which the temperature difference between water above and below the thermocline can prevent mixing between the different regions of water. Thermoclines play an important role in aquaculture as an ecological boundary in aquatic environments. For example, a thermocline can impact nutrient gradients, e.g., the dispersion of nutrients in an aquatic ecosystem and can demonstrate a boundary layer indicating physiological temperature limits of the livestock and other inhabitants of an aquaculture environment. For example, livestock such as fish, crustaceans, and marine parasites, e.g., sea lice, can have ideal environmental conditions for reproduction, growth, and survival. Particular types of livestock, such as fish for example, can be influenced to stay above or below the thermocline based on physiological conditions. As another example, sea lice thrive in a favorable temperature region corresponding to a location above or below a thermocline. For those reasons, it is advantageous to farmers to determine locations of thermoclines.

Since thermoclines are temperature phenomena, it is possible to use thermometers to locate thermoclines. However, the location of thermoclines can change over time, so statically located thermometers are often ineffective in locating thermoclines. Aquaculture environments often contain mobile rigs that contain sensors such as cameras, but such rigs typically do not include thermometers, and introducing thermometers can increase the technical complexity of a rig and introduce an additional point of potential failure. Further, if warm-blood livestock are being farmed, body temperature of livestock can influence a thermometer reading.

Instead, the techniques of this specification use livestock behavior as a signal for determining the location of a thermocline. Since livestock behavior, including the distribution of livestock across various depths, is strongly influenced by thermoclines, livestock behavior itself serves as a sensor that can be used to locate thermoclines, eliminating the need for additional sensors in the environment.

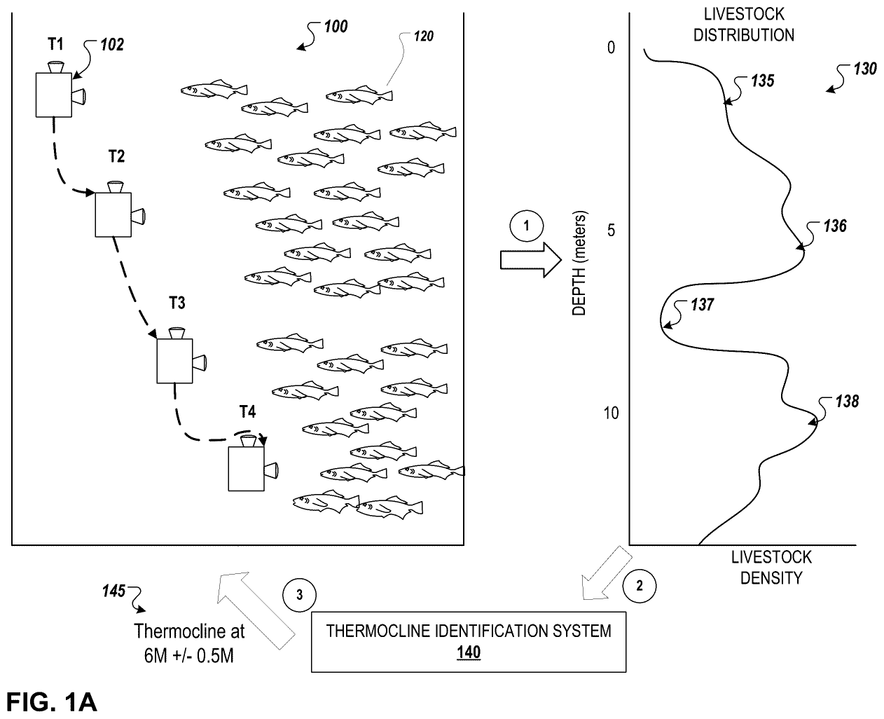

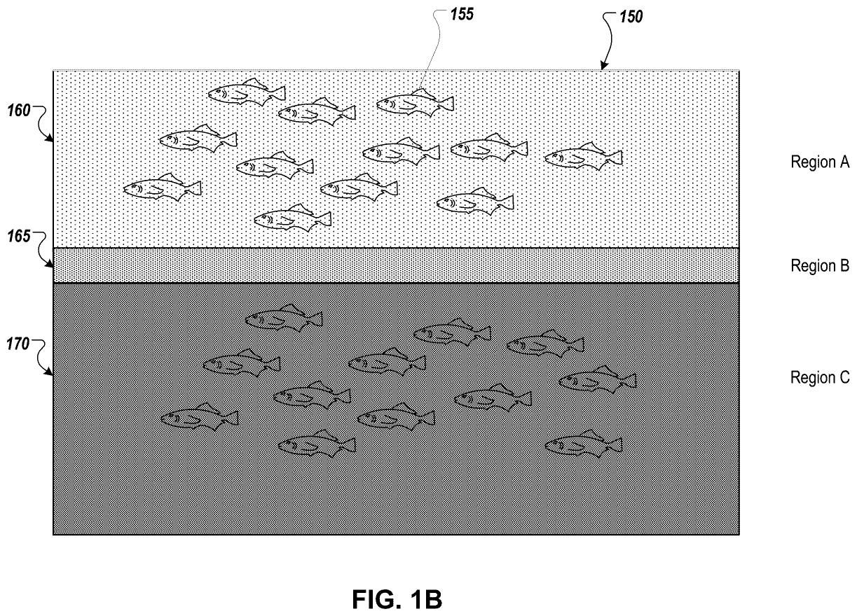

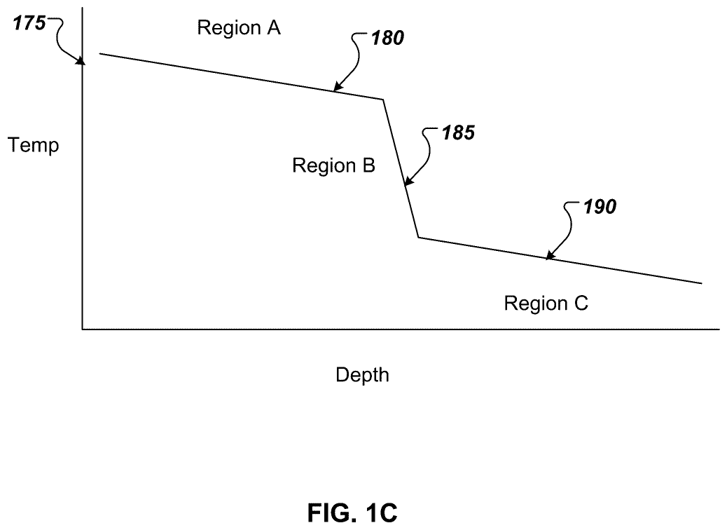

FIG. 1A shows a schematic diagram illustrating an example process of determining thermoclines, including diurnal thermoclines, in an aquaculture environment. As illustrated, FIG. 1A depicts the varying locations of a sensor rig 102 within an aquaculture enclosure 100 at four time instances, T1, T2, T3 and T4. The rig 102 is illustrated at a different location for each time instance. At each location, the rig 102 can capture sensor data 120, which includes images of the livestock. The sensor data 120 can be used to produce a livestock distribution 135, which can be rendered as a graph 130 and transmitted to a thermocline identification system 140. The distribution can include multiple peaks (e.g., peaks 136, 138) and a valley (e.g., valley 137). As described further below, since livestock tend to avoid thermoclines, a thermocline identification system can use the sensor data 120 to produce a predicted location 145 of a thermocline, which can correspond to the valley 137 in the livestock distribution 135.

FIG. 1B shows a schematic diagram of an example process of locating a thermocline in an aquaculture environment. The aquaculture enclosure 150 contains region A 160, which is an upper layer of water, region B 165, which contains a thinner middle layer of water, and region C 170, which contains a lower layer of water. In this example, fish 155 are present in region A 160 and in region C 170, but not in region B 165, and a thermocline identification can use information about the location of fish to make determinations about the location of thermoclines.

FIG. 1C shows a graph 175 illustrating a plot of water temperature relative to the depth of water in the aquaculture enclosure 150. The line 180 representing the temperature at various depths in region A 160 shows a gentle temperature gradient, as does line 190 representing the temperature at various depths of region C 170. In contrast, the line 185 representing the temperature at various depths in region C 165 shows a much steeper temperature gradient, indicating a thermocline. The absence of fish in region B 165 corresponds with the presence of a thermocline at that depth.

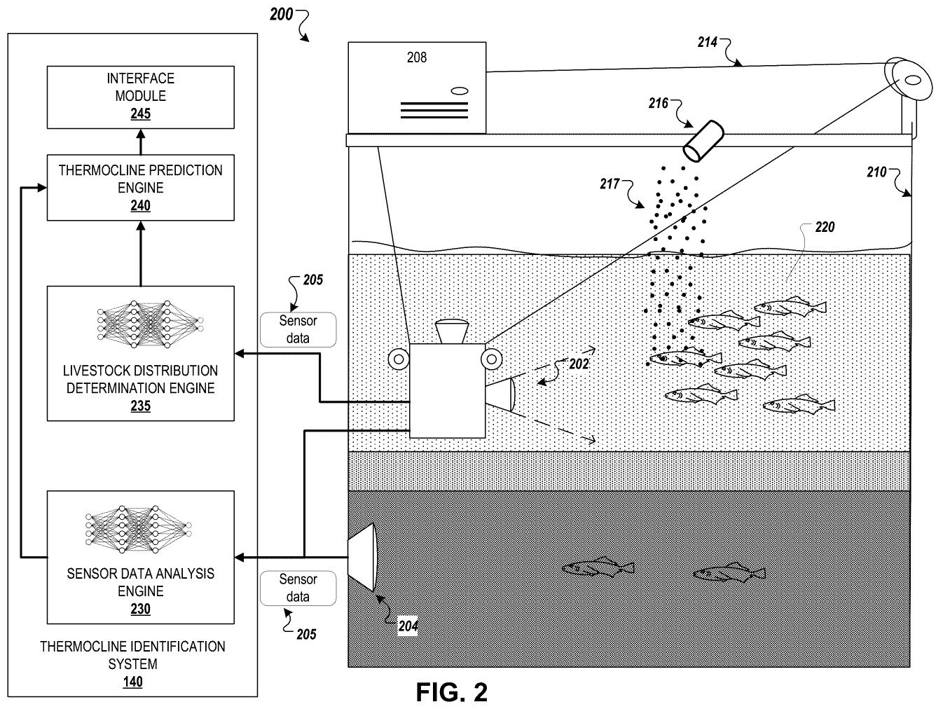

FIG. 2 shows an example of an environment for determining thermoclines in an aquaculture environment. The environment 200 can include an aquaculture enclosure 210 (enclosure 210 for brevity) and thermocline identification system 140.

The enclosure 210 may enclose livestock 220 that can be aquatic creatures which can swim freely within the confines of the enclosure 210. In some implementations, the aquatic livestock 220 stored within the enclosure 210 can include finfish or other aquatic lifeforms. The livestock 220 can include, for example, juvenile fish, koi fish, salmon, bass, bivalves or crustaceans, e.g., shrimp, to name a few examples. In addition to the aquatic livestock 220, the enclosure 210 contains water, e.g., seawater, freshwater, or rainwater, although the enclosure can contain any fluid that is capable of sustaining a habitable environment for the aquatic livestock 220.

The enclosure 210 can take various forms, such as a physical enclosure or an open body of water. In some implementations, the enclosure 210 is anchored to a structure, e.g., a pier, dock, or buoy. In some implementations, the livestock 220 roam a body of water, e.g., instead of being confined within the enclosure 210, and camera sensor subsystems 202 monitor livestock 220 within a portion of the body of water without the enclosure 210.

The enclosure 210 can include one or more sensor subsystems 202, 204, which can be mobile or fixed. In some implementations, a winch system 208 can move a camera sensor subsystem 202 up and down to different depths in the enclosure 210. For example, the camera sensor subsystem 202 may patrol up and down within the enclosure 210 while it monitors fish feeding. The winch subsystem 208 can include one or more motors, one or more power supplies, and one or more pulleys to which the cord 214, which suspends the camera sensor subsystem 202, is attached. A pulley is a machine used to support movement and direction of a cord, such as cord 214. Although the winch subsystem 208 includes a single cord 214, any configuration of one or more cords and one or more pulleys that allows the camera sensor subsystem 202 to move and rotate, as described herein, can be used.

In some implementations, the camera sensor subsystem 202 can be included in an underwater vehicle such as a remotely operated vehicle (ROV). An ROV is a mobile tethered device configured to operate underwater. Operational commands such as navigation instructions and power can be directed to the ROV from a base station through a tether. Autonomous underwater vehicles can also carry camera sensor subsystems 202.

The winch subsystem 208 may activate one or more motors to move the cord 214. The cord 214, and the attached camera sensor subsystem 202, can be moved along the x-, y-, and z-directions, to a position corresponding to a received instruction. A motor of the winch subsystem 208 can be used to rotate the camera sensor subsystem 202 to adjust the horizontal angle and the vertical angle of the sensor subsystem. A power supply can power the individual components of the winch subsystem. The power supply can provide AC and DC power to each of the components at varying voltage and current levels. In some implementations, the winch subsystem can include multiple winches or multiple motors to allow motion in the x-, y-, and z-directions.

Each camera sensor subsystem 202 can include one or more image capture devices that each can point in various directions, such as up, down, to any side, or at other angles. Each camera sensor subsystem 202 can take images, which can be still images or video, using any of its included imaging devices, and an enclosure 210 can contain multiple camera sensor subsystems 202.

The data provided by the camera sensor subsystem 202 can also include metadata related to sensor measurements. Such metadata can include any information about the camera subsystem 202, including information about captured images. For example, metadata can include an identifier of the camera sensor subsystem 202 that captured the reading, the time the reading was captured, the location of the sensor (e.g., the depth of the camera sensor subsystem 202) at the time the reading was taken, and so on. Metadata can be encoded in any appropriate format. For example, metadata can be encoded as Extensible Markup Language (XML).

The environment 200 can further include one or more feeding mechanisms 216 that can provide feed 217 to the livestock 220. The feeding mechanism 216 can include a pipe connecting the enclosure 210 to a central feeding station that provides the feed 217 to the enclosure 210. In some implementations, a distributor located at the enclosure 210 can be used to more evenly distribute the feed 217 within the enclosure 210. For example, the distributor can move around the surface of the enclosure 210 while dropping the feed 217 for the livestock 220. In some cases, a device can be used to propel the feed 217. For example, a blower that blows air or water with the feed 217 can be used to disperse the feed 217. Feeding mechanisms 216 can also include sensors that can monitor the feeding process. For example, a feeding mechanism sensor can monitor the amount of feed disbursed over a given time period, the maximum and minimum rates of feed injection, and so on.

The environment 200 can include various additional sensors 204 such as sensors 204 that measure properties of the environment 200. For example, one or more sensors 204 can measure water properties such as dissolved oxygen, pH and salinity, among many other examples. In another example, one or more sensors 204 can measure weather information, such as barometric pressure, wind speed, rainfall amounts, and so on. Note that while the sensor 204 is illustrated as being at a particular underwater location, sensors 204 can be located at any position within the enclosure 210 and in positions outside the enclosure 210, including outside the water.

The thermocline identification system 140 can be configured to generate estimations of thermocline locations. The thermocline identification system 140 can include a sensor data analysis engine 230, a livestock distribution determination engine 235, a thermocline prediction engine 240 and a interface module 245.

The sensor data analysis engine 230 can accept sensor data 205 from the camera sensor subsystems 202 and from other sensor types 204. Sensor data 205 from the camera sensor subsystems 202 can include one or more still images and/or videos. Sensor data 205 from other sensors 204 can include one or more values indicating a measured property of the environment. Sensor data 205 can also include metadata such as an identifier of the sensor 202, 204 that captured the sensor reading, the type of data (e.g., salinity reading, still image, etc.), the time of capture, the location of the sensor 202, 204, and so on. Sensor data 205 can be encoded in any appropriate format. For example, sensor data 205 can be encoded as a compressed binary format, a structured text (e.g. XML) format that can contain the sensor 202, 204 readings, other formats, or combinations of formats. Sensor data 205 that is image data can be in any appropriate image format, including Joint Photographic Experts Group (JPEG), the raw image format (RAW), Tag Image File Format (TIFF), Moving Pictures Expert Group 4 (MPEG-4), and so on.

The sensor data analysis engine 230 can evaluate sensor data 205 using one or more models, e.g., including machine learning models, to determine one or more environment descriptors that describe the environment within the enclosure 210. Environment descriptors can include any value or series of values produced using one or more elements of sensor data 205 taken over one or more periods of time. For example, an environment descriptor can include a series of barometric pressure readings. In another example, the sensor data analysis engine 230 can accept a series of barometric pressure readings and produce an environment descriptor that predicts rainfall and/or wind speed over a future period of time, which can influence the location of livestock. In still another example, a sensor 204 can detect the presence of feed in the enclosure 210 as feed can alter the preferred location of the livestock 220.

The livestock distribution determination engine 235 can accept images produced by the camera sensor subsystems 202 and determine a statistical distribution of fish (or other livestock) over time. For example, the livestock distribution determination engine 235 can determine a temporal mean, which can be a statistical distribution of the estimated number of fish at a range of depths over a period of time. The livestock distribution determination engine 235 can use models that are configured to accept images, which can be still images or video images, and produce a distribution of fish over a period of interest. For example, the livestock distribution determination engine 235 can be a machine learning model, such as a deep neural network. The deep neural network can generate predictions of livestock distributions based on input images of fish at various points in time. Generating predictions based on time-varying distributions can be advantageous compared to distributions at a particular point in time, due to distributions of fish undergoing transient changes, e.g., when the fish feed.

The thermocline prediction engine 240 can accept livestock distributions from the livestock distribution determination engine 235 and, in some implementations, environment descriptors from the sensor data analysis engine 230, and produce a predicted location of one or more thermoclines. The thermocline prediction engine 240 can include one or more models, which can be machine learning models, that accept livestock distributions, and can accept environment descriptors, and produce a predicted location of a thermocline. The prediction can include a depth, a geographic location (e.g., latitude and longitude) or range of locations, a confidence indictor (e.g., the likelihood of that the prediction is correct), an indication of variability (e.g., plus or minus 0.5 meters), and other prediction data. In some implementations, the predication can include multiple depths, and for each depth, a geographic location, a confidence indicator, and so on. In some implementations, the predictions can be for the same geographic location, for different geographic locations, or any combination of the same and/or different locations.

The interface module 245 can accept predictions from the thermocline prediction engine 240 and provide prediction data to devices, including aquaculture management devices such as feeders 216, to monitoring equipment or to users. The interface module 245 can provide prediction data using a variety of techniques. For example, the interface module 245 can transmit the data over a wired or wireless network, such as a Peripheral Component Interconnect Express (PCIe) or an wireless network that uses an 802.11 or Bluetooth standard for providing information wirelessly. The interface module 245 can include a web server or a database engine that can respond to queries from agents interested in the predictions. Predictions can be transmitted, or “pushed,” to devices that have registered an interest in predictions, e.g., by providing the location of a network endpoint to the thermocline identification system 140. The interface module 245 can both push predictions to agents that have registered an interest and respond to queries.

The prediction data can take various forms. For example, the prediction data can be encoded in a structured form such as XML, or encoded as binary data. In another example, the prediction data can be user interface presentation data, which, when rendered by a user device, causes a user interface on the user device to display the prediction.

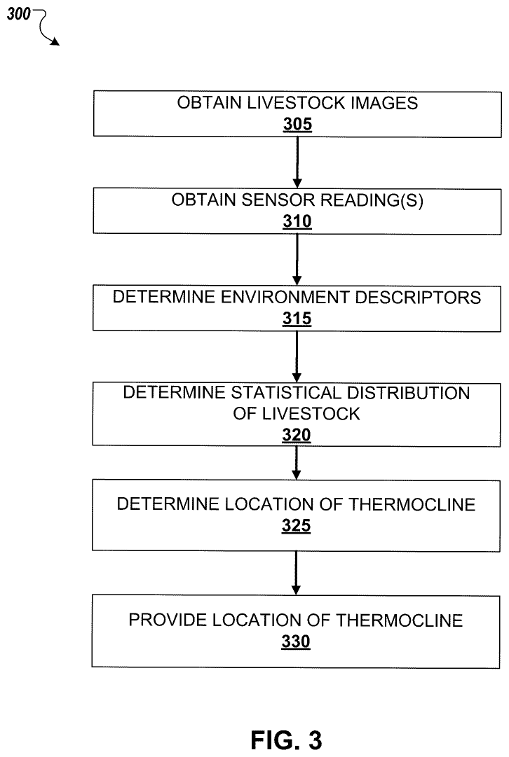

FIG. 3 is a flow diagram of an example process for determining thermoclines in an aquaculture environment. For convenience, the process 300 will be described as being performed by a system for determining thermoclines in an aquaculture environment, e.g., the thermocline identification system 140 of FIGS. 1A-1C and FIG. 2, programmed to perform the process. Operations of the process 300 can also be implemented as instructions stored on one or more computer readable media which may be non-transitory, and execution of the instructions by one or more data processing apparatus can cause the one or more data processing apparatus to perform the operations of the process 300. One or more other components described herein can perform the operations of the process 300.

The system obtains, from at least one imaging device in an aquaculture environment, a plurality of images of livestock in the aquaculture environment (305). As described above, the system can include camera sensor subsystems that can take images using imaging devices included in the camera subsystem. The system can obtain the images transmitted by the camera subsystem using a wired (e.g., PCIe) or wireless (e.g., Bluetooth, 802.11, etc.) network, among other techniques.

The system obtains, from at least one sensor in the aquaculture environment, one or more sensor readings that indicate one or more conditions of the environment in the aquaculture environment (310). As described above, the sensor readings can indicate properties of the environment, such as water properties, weather properties, and so on. In some implementations, the system can obtain sensor reading transmitted by sensors in the aquaculture environment using a wired (e.g., PCIe) or wireless (e.g., Bluetooth or 802.11) network, among other techniques.

The system determines, from the sensor readings at least one environment descriptor using one or more models (315). In some implementations, the system can provide the sensor readings to models that are configured to produce environment descriptors, and the models can then produce environment descriptors used by the system.

Models can take various forms, including mathematical models and machine learning models. For example, a mathematical model can use statistical techniques, such as linear regression, to determine an environment descriptor from sensor readings. In another example, the system can include one or more machine learning models, each configured to produce one or more environment descriptors. The system can provide an input that includes at least a subset of the sensor values to the machine learning models, and the machine learning models can process the input to produce predicted environment descriptors. The machine learning model can be any appropriate type of machine learning model such as a deep neural network (DNN).

The system determines, from at least the plurality of images, a statistical distribution of the livestock in the aquaculture environment (320). The system can include a machine learning model that is configured to accept an input and to produce a statistical distribution of livestock. The input can include images, and in some implementations, the input can further include metadata about images, such as the time of image capture, location of image capture, and so on. The model can be any appropriate type of machine learning model, such as DNN.

The system can provide the input to the machine learning model, and the machine learning model can process the input to produce a statistical distribution. The statistical distribution can include, for each of a series of depths within an area of interest and over a period of time of interest, an estimate of livestock present. The estimate can include the number of livestock present at a given depth, the biomass of the livestock at the given depth, and so on. The estimate can also be a mathematical expression that describes the biomass distribution.

The system determines, from at least the statistical distribution of the livestock, a predicted location of a thermocline in the aquaculture environment (325). In some implementations, the system can also use the environment descriptors to determine the predicted location of the thermocline. The system can include a machine learning model, which can be a DNN, that is configured to accept an input and to produce an estimated location of a thermocline. The input can include the statistical distribution of the livestock and can further include one or more environment descriptors. Environment descriptors can influence the results of the machine learning models since, in some conditions, livestock can tend to school above or below a thermocline depending on environmental conditions. For example, if feed is present above a thermocline, livestock can disproportionally congregate above the thermocline. Therefore, knowledge of the presence of feed, e.g., as reflected in an environment descriptor, can improve the accuracy of a predicted thermocline.

The system can provide the input to the machine learning model, and the machine learning model can process the input to produce the predicted location of the thermocline. The machine learning model can further be configured to produce the depth of the thermocline and/or a confidence interval, e.g., the distance above and below the predicted thermocline at which the system can a specified confidence (e.g., 85%, 90%, 95%, etc.).

In some implementations, the system can use a mathematical model that is not a machine learning model. For example, as illustrated in FIG. 1A, livestock distributions can have an area of greater density above (136) and below (138) the thermocline, and a valley (137) in the area of the thermocline. The system can use appropriate statistical techniques, such as curve fitting, to determine the location of the valley, and use the median depth of the valley to determine a predicted location of the thermocline.

The system provides, to one or more aquaculture management devices in the aquaculture environment, a signal indicative of the determined location of the thermocline, and the signal can cause a modification of the operation of the devices (330). The system can provide the signal using any appropriate transmission technique, such as providing the signal over a wired or wireless network. In some implementations, the system can further transmit the signal to a management console, for example, transmitting the signal over a wired or wireless network. In another example, the system can transmit user interface presentation data to a user device. When rendered by the user device, the user interface presentation data causes the user device to display the predicted location of the thermocline.

In response to receiving the signal indicative of the predicted location of the thermocline, an aquaculture management device can perform an appropriate action. For example, a feeder device can be configured to provide feed above the thermocline, and/or not within the thermocline. In another example, a mobile camera subsystem can be directed to take relatively more images above or below the thermocline than within the thermocline. In still another example, a parasite remediation system can be deployed based on the predicted location of the thermocline.

While this specification has largely described techniques for determining the location of thermoclines, including diurnal thermoclines, in an aquaculture environment, the techniques can also be used in other environments. For example, in an agriculture environment, images can be used to determine clustering patterns of livestock, and the absence of livestock in a region can be used to determine a predicted location of an irritant such as a pest or parasite. Such information can be used to direct automatic or manual remediation procedures to remove the irritant, which can benefit the livestock. Similarly, a cluster of livestock can be used to identify the location of feed or water, while the absence of livestock can indicate an absence of feed or water. Such information can be used to direct agriculture systems to provide feed and/or water at various locations, which can improve the health and well-being of the animals.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method comprising:
obtaining a plurality of images from at least one imaging device in an aquaculture environment, each image in the plurality of images representing livestock in the aquaculture environment;
determining, from at least the plurality of images, a statistical distribution of the livestock in the aquaculture environment;
determining, from the statistical distribution of the livestock, a location of a thermocline in the aquaculture environment; and
providing, to an aquaculture management device in the aquaculture environment, a signal indicative of the location of the thermocline.

2. The computer-implemented method of claim 1, further comprising:
determining, based on the location of the thermocline, that the thermocline is a diurnal thermocline; and
based on determining that the thermocline is a diurnal thermocline, modifying operation of the aquaculture management device.

3. The computer-implemented method of claim 2, wherein the aquaculture management device is a feeder and modifying operation of the feeder comprises:
adjusting, according to the signal indicative of the location of the thermocline, at least one of (i) an amount of feed to disperse, or (ii) a location in the aquaculture environment to disperse the feed.

4. The computer-implemented method of claim 2, wherein the aquaculture management device is a parasite remediation system, wherein operations of the parasite remediation system are adjusted based on to the signal indicative of the location of the thermocline.

5. The computer-implemented method of claim 2, wherein the aquaculture management device is a camera device and modifying operation of the camera device comprises:
adjusting, based on to the signal indicative of the location of the thermocline, at least one of (i) a position, or (ii) a capture rate, of the camera device.

6. The computer-implemented method of claim 1, further comprising:
obtaining, from at least one sensor in the aquaculture environment, one or more sensor readings comprising at least one measurement of the aquaculture environment.

7. The computer-implemented method of claim 6, wherein the location of a thermocline is determined, at least in part, using the one or more sensor readings.

8. The computer-implemented method of claim 7, further comprising:
determining, from at least one sensor reading among the one or more sensor readings, at least one environment descriptor for the aquaculture environment; and
estimating the location of a thermocline according to the at least one environmental descriptor;
wherein the at least one environmental descriptor indicates a predicted measure of the aquaculture environment.

9. The computer-implemented method of claim 1, wherein the location of a thermocline is determined by a machine learning model.

10. The computer-implemented method of claim 1, wherein the location of a thermocline is determined by a model configured to perform one or more statistical techniques.

11. The computer-implemented method of claim 1, wherein the statistical distribution comprises one or more measurements of estimated number of livestock in the aquaculture pen, each measurement representing a number of livestock in the aquaculture environment at a corresponding depth of the aquaculture environment.

12. The computer-implemented method of claim 1, wherein the statistical distribution comprises one or more measurements of estimated biomass in the aquaculture pen, each measurement representing biomass of the aquaculture environment at a corresponding depth of the aquaculture environment.

13. A system comprising one or more computers and one or more storage devices storing instructions that when executed by the one or more computers cause the one or more computers to perform operations comprising:
obtaining a plurality of images from at least one imaging device in an aquaculture environment, each image in the plurality of images representing livestock in the aquaculture environment;
determining, from at least the plurality of images, a statistical distribution of the livestock in the aquaculture environment;
determining, from the statistical distribution of the livestock, a location of a thermocline in the aquaculture environment; and
providing, to an aquaculture management device in the aquaculture environment, a signal indicative of the location of the thermocline.

14. The system of claim 13, the operation further comprising:
determining, based on the location of the thermocline, that the thermocline is a diurnal thermocline; and
based on determining that the thermocline is a diurnal thermocline, modifying operation of the aquaculture management device.

15. The system of claim 13, wherein the aquaculture management device is a feeder and modifying operation of the feeder comprises:
adjusting, according to the signal indicative of the location of the thermocline, at least one of (i) an amount of feed to disperse, or (ii) a location in the aquaculture environment to disperse the feed.

16. The system of claim 13, wherein the aquaculture management device is a parasite remediation system, wherein operations of the parasite remediation system are adjusted based on the signal indicative of the location of the thermocline.

17. The system of claim 13, wherein the aquaculture management device is a camera device and modifying operation of the camera device comprises:
adjusting, based on the signal indicative of the location of the thermocline, at least one of (i) a position, or (ii) a capture rate, of the camera device.

18. The system of claim 13, the operations further comprising:
obtaining, from at least one sensor in the aquaculture environment, one or more sensor readings comprising at least one measurement of the aquaculture environment; and
determining, based on the one or more sensor readings, the location of a diurnal thermocline;
determining, from at least one sensor reading among the one or more sensor readings, at least one environment descriptor for the aquaculture environment; and
estimating the location of a thermocline according to the at least one environmental description;
wherein the at least one environmental descriptor indicates a predicted measure of the aquaculture environment.

19. The system of claim 13, wherein the location of a thermocline is determined by at least one of (i) a machine learning model, or (ii) a model configured to perform one or more statistical techniques.

20. One or more non-transitory computer-readable storage media storing instructions that when executed by one or more computers cause the one or more computers to perform operations comprising:
obtaining a plurality of images from at least one imaging device in an aquaculture environment, each image in the plurality of images representing livestock in the aquaculture environment;
determining, from at least the plurality of images, a statistical distribution of the livestock in the aquaculture environment;
determining, from the statistical distribution of the livestock, a location of a thermocline in the aquaculture environment; and
providing, to an aquaculture management device in the aquaculture environment, a signal indicative of the location of the thermocline.
